(19) United States
(12) Patent Application Publication
(10) Pub. No.: US 2014/0148053 A1
(43) Pub. Date: May 29, 2014

(54) LINE FILTER, IMAGE FORMING APPARATUS, AND ELECTRONIC DEVICE

(71) Applicant: KYOCERA DOCUMENT SOLUTIONS INC., Osaka (JP)

(72) Inventor: Hidehiko KOJO, Osaka (JP)

(73) Assignee: KYOCERA DOCUMENT SOLUTIONS INC., Osaka (JP)

(21) Appl. No.: 14/089,474

(22) Filed: Nov. 25, 2013

(30) Foreign Application Priority Data
Nov. 27, 2012 (JP) 2012-258705

(51) Int. Cl. H01R 13/648; G03G 15/00

(52) U.S. Cl. CPC G03G 15/80; H01R 13/648
USPC 439/607.01; 399/90

(57) ABSTRACT

A line filter includes a flat plate-shaped cable and a flat core. A through hole is formed in the core. The cable includes: a first penetrating portion which enters the through hole in the core from an inlet of the through hole and is passed through an outlet of the through hole; a second penetrating portion which enters the through hole in the core from the inlet of the through hole and is passed through the outlet of the through hole; and a first connecting portion which connects the first penetrating portion on a side of the outlet of the through hole to the second penetrating portion on a side of the inlet of the through hole not through the through hole. When viewed in a normal direction of a main surface of the core, the second penetrating portion overlaps with the first penetrating portion at least partially.

### INCORPORATION BY REFERENCE

The present application claims priority under 35 U.S.C. §119 to Japanese Patent Application No. 2012-258705, filed Nov. 27, 2012. The contents of this application are incorporated herein by reference in their entirety.

### BACKGROUND

The present disclosure relates to line filters, image forming apparatuses, and electronic devices.

Some electronic devices use a plate-shaped flat cable for signal communications from a substrate to a substrate. A problem of electromagnet interference (EMI) arises which is unnecessary noise radiation by the cable when electric current flows in the cable. In order to reduce the unnecessary noise radiation by the cable, a line filter has been used.

Reduction in unnecessary noise radiation by the cable has been examined. FIG. 9 presents schematic illustrations showing some line filters 800. A line filter 800 shown in FIG. 9A can reduce unnecessary noise radiation by a cable 820 in a manner that the cable 820 is passed through a core 810.

However, reduction in unnecessary noise radiation by the cable 820 may be insufficient in the line filter 800 in FIG. 9A. For this reason, two cores 810 are provided in some cases. Alternatively, a cable 820 is wound to a core 810 to reduce unnecessary noise radiation by the cable 820 in the line filter 800 shown in FIG. 9B. When the cable 820 is wound to the core 810, as shown in FIG. 9B, impedance increases double. This can further reduce the unnecessary noise radiation by the cable 820.

However, the core 810 of the line filter 800 shown in FIG. 9B has a width about two times larger than the line filter 800 shown in FIG. 9A, which may increase the cost. For this reason, a plurality of insertion holes to allow the cable to pass therethrough are formed at regular intervals in some line filters. The cable is alternately passed through the plurality of insertion holes, so that an effect of reduction in unnecessary noise radiation by the cable can be obtained without increasing the width of the core to a degree equivalent to an effect by winding the cable.

### SUMMARY

A line filter according to the present disclosure includes a flat plate-shaped cable and a flat core. A through hole having a shape corresponding to the cable is formed in the core. The cable includes: a first penetrating portion which enters the through hole in the core from an inlet of the through hole and is passed through an outlet of the through hole; a second penetrating portion which enters the through hole in the core from the inlet of the through hole and is passed through the outlet of the through hole; and a first connecting portion which connects the first penetrating portion on a side of the outlet of the through hole to the second penetrating portion on a side of the inlet of the through hole not through the through hole. When viewed in a normal direction of a main surface of the core, the second penetrating portion overlaps with the first penetrating portion at least partially.

An image forming apparatus according to the present disclosure includes the above line filter.

An electronic device according to the present disclosure includes the above line filter.

### BRIEF DESCRIPTION OF THE DRAWINGS

FIG. 1 is a schematic illustration showing a line filter according to one embodiment of the present disclosure.

FIGS. 2A-2D are schematic illustrations showing a manner to pass a cable through a core according to the present disclosure.

FIG. 3 is a schematic illustration showing a line filter according to one embodiment of the present disclosure.

FIG. 4 is a schematic illustration showing a line filter according to another embodiment of the present disclosure.

FIG. 5 is a schematic side view showing an image forming apparatus according to one embodiment of the present disclosure.

FIG. 6 is a schematic perspective view showing the image forming apparatus according to the embodiment of the present disclosure.

FIG. 7A is a schematic tope view showing an image reading section in Comparative Example, and FIG. 7B is a schematic tope view showing an image reading section according to one embodiment of the present disclosure.

FIG. 8 is schematic illustration showing connection between the line filter and the image reading section according to one embodiment of the present disclosure.

FIGS. 9A and 9B are schematic illustrations showing conventional line filters.

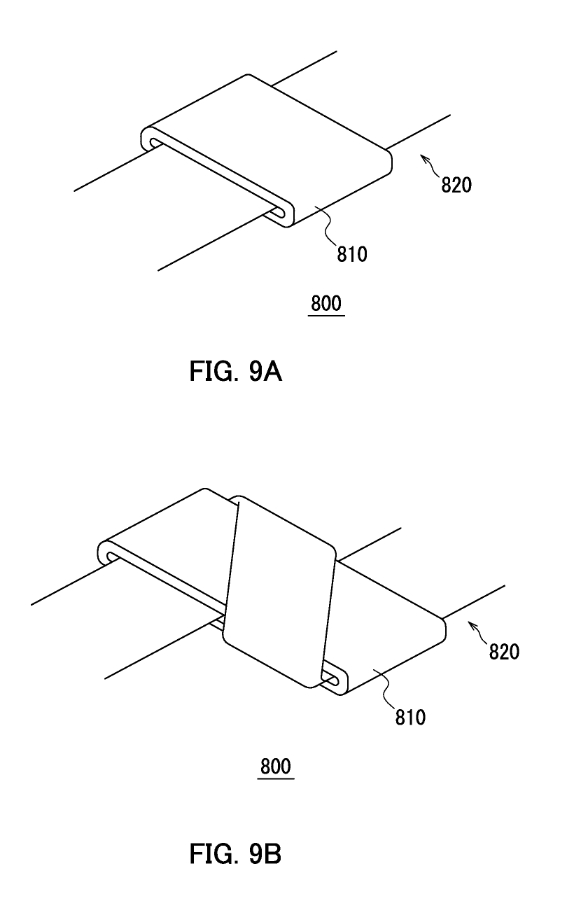

### DETAILED DESCRIPTION

With reference to the accompanying drawings, description will be made below about a line filter, an image forming apparatus, and an electronic device according to embodiments of the present disclosure. It should be noted that the present disclosure is not limited to the following embodiments.

[Basic Configuration: Line filter]

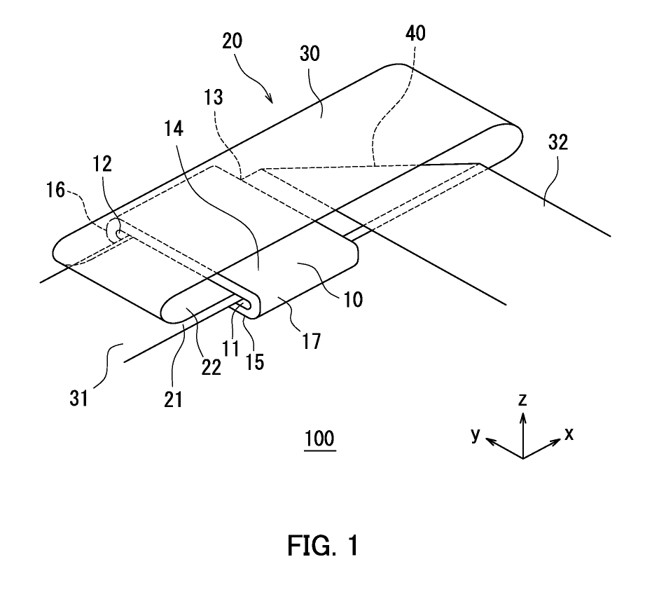

A line filter 100 according to one embodiment of the present disclosure will be described with reference to FIG. 1. FIG. 1 is a schematic illustration showing a line filter 100 according to the embodiment of the present disclosure. The line filter 100 includes a core 10 and a cable 20. The line filter 100 reduces unnecessary noise radiation by the cable 20 in a manner that the cable 20 is passed through the core 10.

The core 10 is a ferrite core, for example. An through hole 11 with a shape corresponding to the cable 20 is formed in the core 10. The through hole 11 defined by the core 10 extends from an inlet 12 to an outlet 13 in a pass through direction (x direction). The core 10 has a flat shape. The core 10 has a surface 14, a surface 15, a surface 16, and a surface 17. The surfaces 14, 15, 16, and 17 continue to one another.

The area of the surfaces 14 and 15 is larger than that of the surfaces 16 and 17. The surfaces 14 and 15 may be referred to as main surfaces 14 and 15 in the present specification.

A direction where a diameter of the through hole 11 in the core 10 is maximum is defined as a y direction in the present specification. By contrast, the direction parallel to the pass though direction of the through hole 11 in the core 10 is defined as an x direction. Further, the normal direction of the main surface 14 of the core 10 is defined as a z direction. The z direction is orthogonal to the x direction and the y direction.

The cable 20 has a flat plate shape. The cable 20 is a flexible flat cable (FFC) or a flexible printed circuit (FPC), for example.

The cable 20 includes a first penetrating portion 21, a second penetrating portion 22, and a connecting portion 30. The first penetrating portion 21 enters the through hole 11 in the core 10 from the inlet 12 of the through hole 11 and is passed through the outlet 13 of the through hole 11. The second penetrating portion 22 enters the through hole 11 in the core 10 from the inlet 12 of the through hole 11 and is passed through the outlet 13 of the through hole 11. The connecting portion 30 connects the first penetrating portion 21 on the side of the outlet 13 of the through hole 11 to the second penetrating portion 22 on the side of the inlet 12 of the through hole 11 not through the through hole 11. When the first penetrating portion 21 and the second penetrating portion 22 are viewed in the normal direction (z direction) of the main surface 14 of the core 10, the direction in which the first penetrating portion 21 extends is in parallel to the direction in which the second penetrating portion 22 extends. The line filter 100 has a configuration in which the cable 20 is passed through the through hole 11 in the core 10 twice. It is noted that the connecting portion 30 may be referred to as a first connecting portion in the present specification.

The cable 20 further includes a first main body portion 31, a second main body portion 32, and a folded portion 40. The first main body portion 31 continues to the first penetrating portion 21. The second main body portion 32 continues to the second penetrating portion 22 through the folded portion 40. The second main body portion 32 extends in a direction in which the cable 20 is folded at the folded portion 40 relative to the direction in which the second penetrating portion 22 extends.

Where the line filter 100 is viewed in the normal direction (z direction) of the main surface 14 of the core 10, the direction in which the first penetrating portion 21 extends is in parallel to the direction in which the second penetrating portion 22 extends.

The core 10 has a flat shape. The diameter of the through hole 11 in the core 10 is larger in the y direction than in the z direction. As described above, the through hole 11 in the core 10 has a shape corresponding to the cable 20. Specifically, where focus is placed on the first penetrating portion 21 and the second penetrating portion 22 of the cable 20, the diameter of the first penetrating portion 21 in the direction (y direction) where the diameter of the through hole 11 in the core 10 is maximum is larger than the diameter of the first penetrating portion 21 in the direction (z direction) orthogonal to the y direction. The diameter of the second penetrating portion 22 in the direction (y direction) where the diameter of the through hole 11 in the core 10 is maximum is larger than the diameter of the second penetrating portion 22 in direction (z direction) orthogonal to the y direction. A direction of the maximum diameter in a cross section perpendicular to the direction in which the first penetrating portion 21 and the second penetrating portion 22 extend is in parallel to the direction of a maximum diameter of the through hole 11 in the core 10. Accordingly, the cable 20 is hard to shift. Further, the inner diameter of the core 10 in the z direction can be reduced.

Further, in the present embodiment, where the line filter 100 is viewed in the normal direction (z direction) of the main surface 14 of the core 10, the second penetrating portion 22 entirely (at least partially) overlaps with the first penetrating portion 21 in the through hole 11 in the core 10. Accordingly, the inner diameter of the core 10 in the y direction can be reduced.

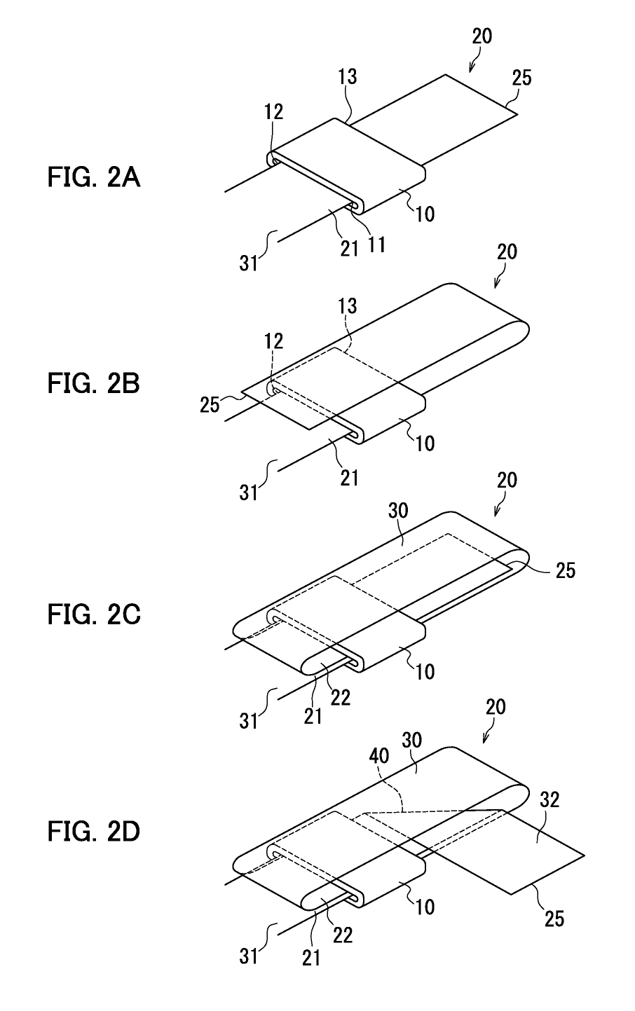

Description will be given with reference to FIG. 2 about a manner to pass the cable 20 through the core 10 according to the present disclosure. FIG. 2 is a schematic illustration showing a manner to pass the cable 20 through the core 10 according to the present disclosure.

First, as shown in FIG. 2A, a tip end 25 of the cable 20 enters the through hole 11 in the core 10 from the inlet 12 and is passed through the outlet 13, thereby forming the first penetrating portion 21.

Next, as shown in FIG. 2B, the tip end 25 of the cable 20 is turned to be returned to the inlet 12 of the core 10 from the outside of the core 10. Further, as shown in FIG. 2C, the tip end 25 of the cable 20 enters the through hole 11 in the core 10 from the inlet 12 and is passed through the outlet 13, thereby forming the connecting portion 30 and the second penetrating portion 22.

Then, as shown in FIG. 2D, the linearly extending cable 20 is folded at the folded portion 40, thereby forming the second main body portion 32.

Thus, the cable 20 is wound around the core 10 as described with reference to FIGS. 2A-2D, thereby forming the line filter 100.

It is noted that as described with reference to FIG. 1, when the line filter 100 is viewed in the normal direction (z direction) of the main surface 14 of the core 10, the second penetrating portion 22 overlaps with the first penetrating portion 21 at least partially. Thus, the core 10 can be reduced in width in the y direction. Accordingly, unnecessary noise radiation by the cable 20 can be reduced without involving an increase in number of cores and an increase in width of the core.

The second penetrating portion 22 entirely overlaps with the first penetrating portion 21 in the through hole 11 in the core 10 of the line filter 100 shown in FIG. 1. The cable 20 is wound around the core 10 of the line filter 100 in the manner as described with reference to FIG. 1, so that the core 10 can be reduced in width. Accordingly, unnecessary noise radiation can be reduced to an extent equivalent to noise reduction by providing two cores even without involving an increase in width of the core 10.

Further, as described with reference to FIG. 1, the second main body portion 32 extends in the direction in which the cable 20 is folded at the folded portion 40 relative to the direction in which the second penetrating portion 22 extends. This means that the direction in which the second main body portion 32 extends can be changed at the folded portion 40. In the line filter 100 of the present embodiment, the direction in which the second main body portion 32 extends is orthogonal to the direction in which the second penetrating portion 22 extends.

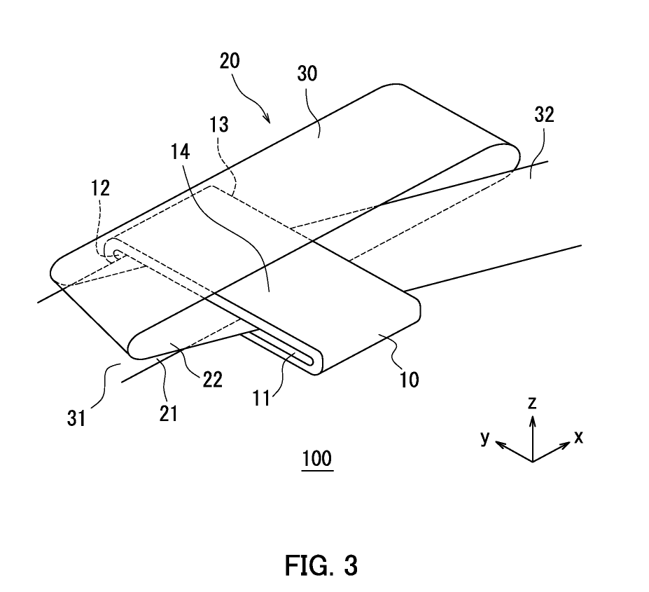

FIG. 3 is a schematic illustration showing a line filter 100 according to one embodiment of the present disclosure. As described above, when the line filter 100 shown in FIG. 1 is viewed in the normal direction (z direction) of the main surface 14 of the core 10, the direction in which the first penetrating portion 21 extends is in parallel to the direction in which the second penetrating portion 22 extends. However, the direction in which the first penetrating portion 21 extends is not limited to the direction in parallel to the direction in which the second penetrating portion 22 extends.

Where the line filter 100 is viewed in the normal direction (z direction) of the main surface 14 of the core 10, the direction in which the first penetrating portion 21 extends can cross the direction in which the second penetrating portion 22 extends. When the line filter 100 shown in FIG. 3 is viewed in the normal direction (z direction) of the main surface 14 of the core 10, the first penetrating portion 21 and the second penetrating portion 22 partially overlap with each other. The technical scope of the present disclosure encompasses this configuration. Further, the folded portion may not be formed.

### [Three Turn: Line Filter]

It is noted that although the line filters 100 shown in FIGS. 1 and 3 each have a configuration in which the cable 20 is passed through the through hole 11 in the core 10 twice, the line filter 100 may have a configuration in which the cable 20 is passed through the through hole 11 in the core 10 three or more times.

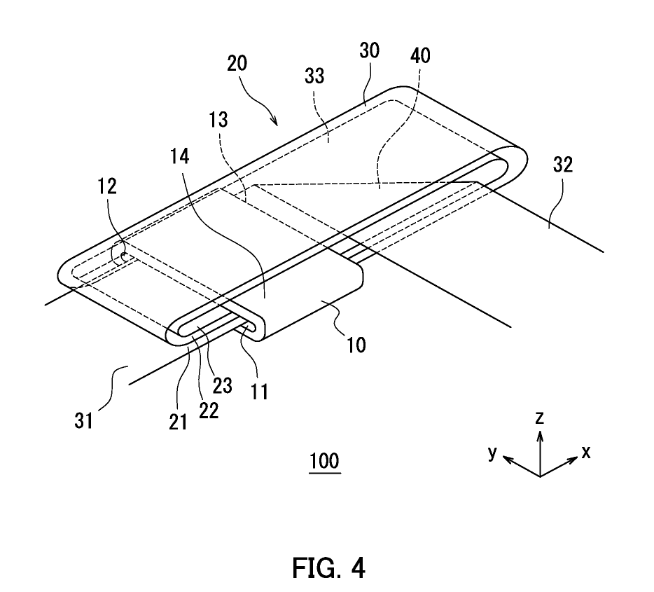

A line filter 100 in another embodiment of the present disclosure will be now described with reference to FIG. 4. FIG. 4 is a schematic illustration showing a line filter 100 according to another embodiment of the present disclosure. The line filter 100 has a configuration in which a cable 20 is passed through the through hole 11 in the core 10 three times. The cable 20 of the line filter 100 additionally includes a third penetrating portion 23 and a connecting portion 33. The line filter 100 according to the present embodiment has a similar configuration to that of the line filter 100 described with reference to FIG. 1, except that the cable 20 additionally includes the third penetrating portion 23 and the connecting portion 33. Therefore, description of duplicate parts is omitted. It is noted that the connecting portion 33 may be referred to as a second connecting portion in the present specification.

The third penetrating portion 23 enters the through hole 11 in the core 10 from the inlet 12 of the through hole 11 and is passed through the outlet 13 of the through hole 11. The connecting portion 33 connects the second penetrating portion 22 on the side of the outlet 13 of the through hole 11 to the third penetrating portion 23 on the side of the inlet 12 of the through hole 11 not through the through hole 11. The cable 20 of the line filter 100 is passed through the through hole 11 in the core 10 three times.

Herein, when the line filter 100 is viewed in the normal direction (z direction) of the main surface 14 of the core 10, the first penetrating portion 21, the second penetrating portion 22, and the third penetrating portion 23 entirely (at least partially) overlap one another in the through hole 11 in the core 10. It is noted that the line filter 100 can have a configuration in which the third penetrating portion 23 overlaps partially with at least one of the first penetrating portion 21 and the second penetrating portion 22 when the line filter 100 is viewed in the normal direction (z direction) of the main surface 14 of the core 10. For example, the second penetrating portion 22 may entirely overlap with the first penetrating portion 21 in the through hole 11 in the core 10, while the third penetrating portion 23 may overlap partially with the first penetrating portion 21 and the second penetrating portion 22. Alternatively, the second penetrating portion 22 may overlap partially with the first penetrating portion 21, while the third penetrating portion 23 may overlap partially with at least one of the first penetrating portion 21 and the second penetrating portion 22. Where the configuration is such that the third penetrating portion 23 overlaps partially with at least one of the first penetrating portion 21 and the second penetrating portion 22, the width of the core 10 of the line filter 100 in the y direction can be set smaller than that in the case where the first penetrating portion 21, the second penetrating portion 22, and the third penetrating portion 23 do not overlap one another.

Thus, as described with reference to FIG. 4, when the line filter 100 is viewed in the normal direction (z direction) of the main surface 14 of the core 10, the third penetrating portion 23 overlaps partially with at least one of the first penetrating portion 21 and the second penetrating portion 22. Further, the cable 20 of the line filter 100 is passed through the through hole 11 in the core 10 three times. Accordingly, unnecessary noise radiation by the cable 20 can be further reduced.

### [Image Forming Apparatus]

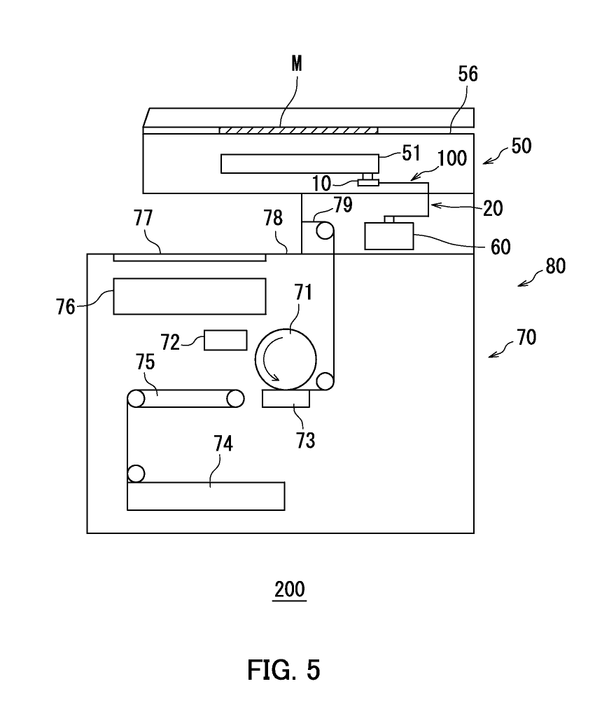

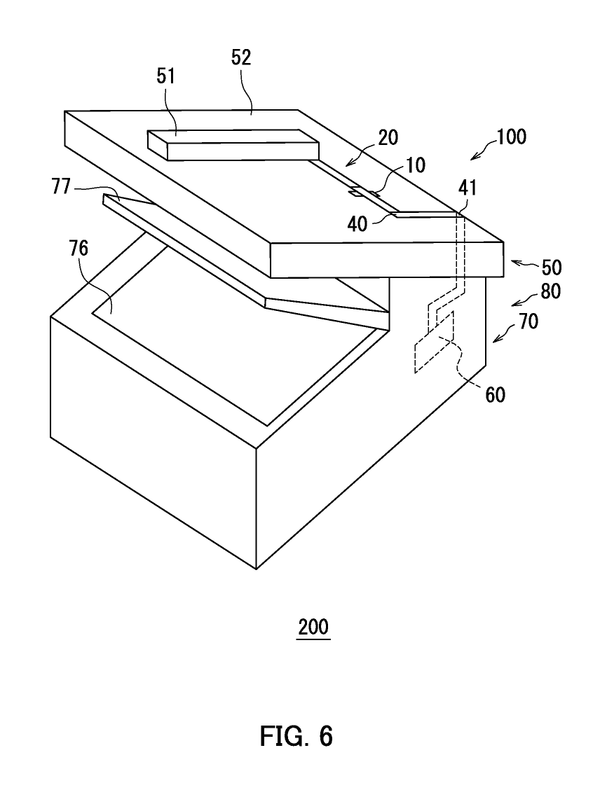

An image forming apparatus 200 according to one embodiment of the present disclosure will now be descried with reference to FIGS. 5 and 6. FIG. 5 is a schematic side view showing an image forming apparatus 200 according to one embodiment of the present disclosure. FIG. 6 is a schematic perspective view showing the image forming apparatus 200 according to the embodiment of the present disclosure.

The image forming apparatus 200 includes any of the line filters 100 described with reference to FIGS. 1-4. The image forming apparatus 200 further includes an image reading section 50, a printing section 70, and a controller 60. Typically, the image forming apparatus 200 additionally includes a document table 56. The image reading section 50 is provided below the document table 56. The controller 60 and the printing section 70 are boarded in the interior of a support box 80. The image forming apparatus 200 reads an original document M loaded on the document table 56 to obtain an input image.

The image reading section 50 includes an imaging section 51. The imaging section 51 reads an original document M to obtain an input image. The image reading section 50 includes a light source (not shown) and an optical system (not shown). The optical system includes a plurality of reflection mirrors and a plurality of lenses. Light emitted from the light source reaches the imaging section 51 through the optical system. Description will be made below about a process where the light emitted from the light source reaches the imaging section 51. The light source irradiates the light upward to the document table 56. The light irradiated from light source is reflected by the original document M and is led by the plurality of reflection mirrors to reach the imaging section 51 through the lenses. In order to read the original document M, the light source that emits the light moves in the normal direction of the paper of FIG. 5.

The imaging section 51 is a charge coupled device (CCD) unit or a contact image sensor (CIS) unit, for example. The imaging section 51 includes a substrate on which an image sensor is boarded. Where the imaging section 51 is a CCD unit, the image sensor is a CCD image sensor. Where the imaging section 51 is a CIS unit, the image sensor is a CMOS image sensor. The image sensor in the imaging section 51 generates electric signals from the light that reaches the imaging section 51.

The imaging section 51 is connected to the controller 60 though the line filter 100. The electric signals generated in the imaging section 51 flow through the cable 20 of the line filter 100 to be input to the controller 60. The controller 60 controls the image reading section 50 and the printing section 70. The controller 60 controls the image reading section 50 to allow the image reading section 50 to read an original document M, thereby obtaining an input image. The controller 60 controls the printing section 70 on the basis of the input image to allow the printing section 70 to print the original document M.

The printing section 70 includes a photosensitive drum 71, a developing section 72, a transfer section 73, a paper feed section 74, a conveyance belt 75, a toner accommodating section 76, a lid 77, a discharge tray 78, and a conveyance belt 79. The printing section 70 is provided under the image reading section 50. In order to print an original document M, a charger (not shown) charges the photosensitive drum 71 first. Then, a laser is irradiated to the surface of the charged photosensitive drum 71 on the basis of the input image to form an electrostatic latent image. Thereafter, the developing section 72 attaches tonner to the electrostatic latent image to form a toner image on the surface of the photosensitive drum 71. Then, the transfer section 73 provides to paper electric charge with a polarity opposite to that of the toner image formed on the surface of the photosensitive drum 71. The toner image formed in the transfer section 73 is transferred to paper conveyed from the paper feed section 74 by the conveyance belt 75. Subsequently, the paper to which the toner image is transferred is conveyed through the conveyance belt 79 and is then ejected to the discharge tray 78.

Connection between the imaging section 51 and the controller 60 will be described next with reference to FIG. 6. FIG. 6 shows a state in which the lid 77 is lifted up in order to fill the toner accommodating section 76 with toner. The controller 60 is provided on the side surface of the support box 80 of the image forming apparatus 200. The cable 20 extending from the imaging section 51 is folded in the horizontal direction at the folded portion 40. The cable 20 is then folded in the perpendicular direction at a fulcrum 41. The cable 20 is further folded in the horizontal direction and then in the perpendicular direction and is then connected to the controller 60. With the line filter 100, unnecessary noise radiation by the cable 20 can be reduced. As shown in FIG. 6, in lifting up the lid 77 in order to fill the toner accommodating section 76 with the toner, the image reading section 50 may be turned about a rotational shaft supported by the support box 80 in some cases so that the image reading section 50 will not disturb.

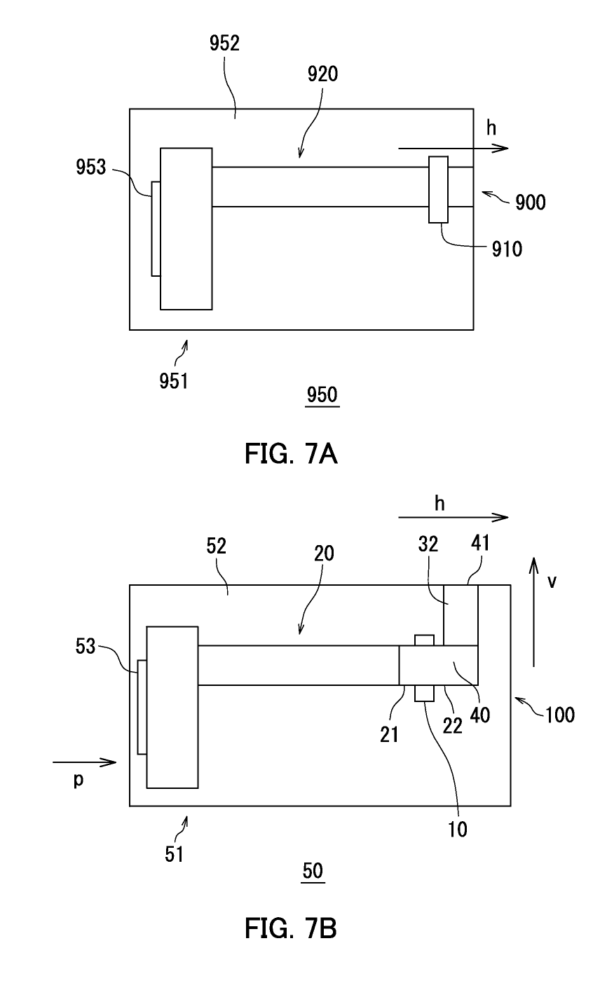

An image forming apparatus 200 according to one embodiment of the present disclosure will be described with reference to FIG. 7. FIG. 7A is a schematic top view showing an image reading section 950 in a comparative example. FIG. 7B is a schematic top view showing an image reading section 50 according to the embodiment of the present disclosure.

As shown in FIG. 7A, the image reading section 950 includes an imaging section 951. The imaging section 951 includes a substrate 953 on which an image sensor is boarded. The imaging section 951 is connected to a line filter 900. The line filter 900 includes a core 910 and a cable 920. The cable 920 passes through a through hole in the core 910 once. The cable 920 is passed through the through hole in the core 910 and then extends in a sub scanning direction h.

As shown in FIG. 7B, an image reading section 50 according to the present embodiment includes an imaging section 51. The imaging section 51 is connected to the line filter 100 shown in FIG. 1. The imaging section 51 includes a substrate 53 on which an image sensor is boarded. The cable 20 connected to the imaging section 51 is drawn downward of the imaging section 51. Then, the cable 20 extends under the imaging section 51 in the sub scanning direction h. The first penetrating portion 21 extends in the sub scanning direction h. The second main body portion 32 is folded at the folded portion 40 and extends in a main scanning direction v. The direction in which the first penetrating portion 21 extends is orthogonal to the direction in which the second main body portion 32 extends. The cable 20 is passed through the through hole in the core 10 twice.

As shown in FIG. 6, in lifting up the lid 77 in order to fill the toner accommodating section 76 with the toner, the image reading section 50 may be turned about the rotational shaft supported by the support box 80 in some cases so that the image reading section 50 will not disturb. In so doing, the cable 920 extends in the direction parallel to the rotational shaft, that is, the sub scanning direction h in the image reading section 950 when viewed in the normal direction of a main surface 952 of the image reading section 950. Accordingly, turning the image reading section 950 may pull the cable 920 to apply stress to the cable 920. This may lead to breakage of the cable 920.

By contrast, when viewed in the normal direction of a main surface 52 of the image reading section 50, the second main body portion 32 extends in the direction crossing the rotational shaft, that is, a main scanning direction v in the image reading section 50. This can move the cable 20 relative to the fulcrum 41, thereby reducing the stress applied to the cable 20. In turn, breakage of the cable 20 can be reduced.

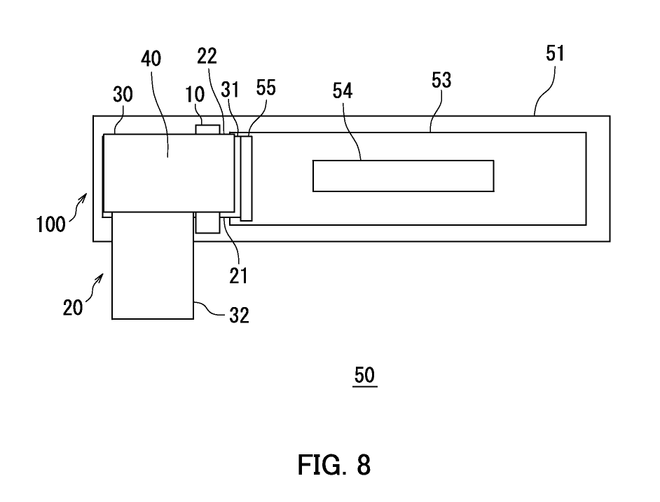

Although the line filter 100 described with reference to FIG. 7B is provided away from the imaging section 51, the line filter 100 may be arranged adjacently to the imaging section 51. Connection between the line filter 100 according to one embodiment of the present disclosure and the image reading section 50 will be described with reference to FIG. 8. FIG. 8 is a schematic illustration showing connection between the line filter 100 according to the present disclosure and the image reading section 50. FIG. 8 shows the imaging section 51 as viewed in the direction indicated by the arrow p in FIG. 7B.

An imaging section 51 of the image reading section 50 includes a substrate 53 on which an image sensor 54 is boarded. The substrate 53 includes a connector 55. Connection of the connector 55 that the substrate includes to a connector provided at the first main body portion 31 can result in connection between the line filter 100 and the substrate 53. The second main body portion 32 is folded downward at the folded portion 40 and extends below the imaging section 51.

Thus, as has been described with reference to FIG. 8, the line filter 100 can be provided adjacent to the image sensor 54. Accordingly, unnecessary noise radiation by the cable 20 can be reduced more than the case where the cable 20 merely extends below the imaging section 51.

The image forming apparatus 200 including the line filter 100 according to the present disclosure has been described with reference to FIGS. 5-8. The line filter 100 of the present disclosure can be provided in another electronic device. For example, the electronic device may be any of personal computers, mobile phones, display devices, such as panels, etc. Provision of the line filter 100 according to the present disclosure in an electronic device can reduce unnecessary noise radiation by the cable 20 provided in the electronic device.

What is claimed is:

1. A line filter comprising:
a flat plate-shaped cable; and
a flat core;
wherein a through hole having a shape corresponding to the cable is formed in the core,
the cable includes:
a first penetrating portion which enters the through hole in the core from an inlet of the through hole and is passed through an outlet of the through hole;
a second penetrating portion which enters the through hole in the core from the inlet of the through hole and is passed through the outlet of the through hole; and
a first connecting portion which connects the first penetrating portion on a side of the outlet of the through hole to the second penetrating portion on a side of the inlet of the through hole not through the through hole, and
when viewed in a normal direction of a main surface of the core, the second penetrating portion overlaps with the first penetrating portion at least partially.

2. A line filter according to claim 1, wherein
when viewed in the normal direction of the main surface of the core, the second penetrating portion entirely overlaps with the first penetrating portion in the through hole.

3. A line filter according to claim 1, wherein
when viewed in the normal direction of the main surface of the core, a direction in which the first penetrating portion extends is in parallel to a direction in which the second penetrating portion extends.

4. A line filter according to claim 1, wherein
the cable includes:
a first main body portion continuing to the first penetrating portion; and
a second main body portion continuing to the second penetrating portion,
the second penetrating portion continues to the second main body portion through a folded portion, and
the second main body portion extends in a direction in which the cable is folded at the folded portion relative to a direction in which the second penetrating portion extends.

5. A line filter according to claim 4, wherein
the direction in which the second main body portion extends is orthogonal to the direction in which the second penetrating portion extends.

6. A line filter according to claim 1, wherein
the cable further includes:
a third penetrating portion which enters the through hole in the core from the inlet of the through hole and is passed through the outlet of the through hole; and
a second connecting portion which connects the second penetrating portion on the side of the outlet of the through hole to the third penetrating portion on the side of the inlet of the through hole not through the through hole, and
when viewed in the normal direction of the main surface of the core, the third penetrating portion overlaps partially with at least one of the first penetrating portion and the second penetrating portion.

7. An image forming apparatus, comprising a line filter according to claim 1.

8. An image forming apparatus according to claim 7, further comprising:
an image reading section including an imaging section configured to obtain an input image by reading an original document;
a printing section configured to print the original document; and
a controller configured to control the image reading section and the printing section,
wherein the imaging section is connected to the controller through the line filter.

9. An image forming apparatus according to claim 8, wherein
the original document is read in a sub scanning direction,
the cable includes:
a first main body portion continuing to the first penetrating portion; and
a second main body portion continuing to the second penetrating portion,
the second main body portion continues to the second penetrating portion through a folded portion and extends in a direction in which the cable is folded at the folded portion relative to a direction in which the second penetrating portion extends, and
the first penetrating portion extends in the sub scanning direction, and
the second main body portion extends in a main scanning direction orthogonal to the sub scanning direction.

10. An image forming apparatus according to claim 9, wherein
the image reading section is turnable about a rotational shaft supported by a support box in the interior of which the controller and the printing section are boarded, and
when viewed in a normal direction of a main surface of the image reading section, the second main body portion extends in a direction crossing the rotational shaft.

11. An electronic device comprising a line filter according to claim 1.
